(19) United States
(12) Patent Application Publication
(10) Pub. No.: US 2009/0221414 A1
(43) Pub. Date: Sep. 3, 2009

(54) Slurry and Ceramic Composite Produced with it

(76) Inventors: Walther Glaubitt, Margetshoechheim (DE); Arne Rudinger, Wuerzburg (DE)

Correspondence Address: JACOBSON HOLMAN PLLC, 400 SEVENTH STREET N.W., SUITE 600, WASHINGTON, DC, 20004, US

(21) Appl. No.: 12/224,940

(22) PCT Filed: Mar. 8, 2007
(86) PCT No.: PCT/EP2007/002041

§ 371 Date: Jan. 29, 2009

(30) Foreign Application Priority Data
Mar. 10, 2006 (DE) 10 2006 011 224.5

(51) Int. Cl. C04B 38/00; C09K 3/00

(52) U.S. Cl. 501/80; 252/182.12; 977/788

(57) ABSTRACT

The invention relates to ceramic slurry from which ductile ceramic fibrous composites can be produced. They can be stretched under tension without any of the brittleness typical for ceramic materials occurring.

The invention relates to ceramic slurry from which ductile ceramic fibrous composites can be produced. They can be stretched under tension without any of the brittleness typical for ceramic materials occurring.

Numerous systems of ceramic slurry for producing oxide ceramic materials and composites are known (e.g., J. Goering et al.; oxide/oxide-composites: production, properties, and application, in W. Krenkel: Keramische Verbundwerkstoffe, 2001, pages 123 through 147, F. F. Lange et al.: oxide/oxide composites: control of microstructure and properties, in 4^{th} International Conference on High Temperature Matrix Composites (HAT-CMC4), 2001, pages 587 through 609, R. A. Simon et al.: colloidal production and properties of novel fiber-reinforced oxide ceramics, in H. P. Degischer: Verbundwerkstoffe, pages 298 through 303, R. A. Simon: Thermal Shock Resistance of Nextel™ 610 and Nextel™ 720 Continuous Fiber-Reinforced Mullite Matrix Composites, in Ceramic Engineering and Science Proceedings, 25 (4), 2004, pages 105 through 110, C. G. Levi et al.: Microstructural Design of Stable Porous Matrices for All-Oxide Ceramic Composites, Z. Metallkd. 90 (1999) 12, pages 1037 through 1047). They are partially aqueous colloid-disperse brines with ceramic filler powders and/or purely aqueous slurry with ceramic filler powders. The slurry sinters at temperatures >1250° C., resulting in damage to enclosed polycrystalline ceramic fibers. Ceramic fiber-composites with ductile properties cannot be produced with such slurry without damaging the reinforcing fibers.

From EP 1 050 520 B1 ceramic slurry is known, with the brine described there forming a dense mullite at sintering temperatures <1250° C.

Based thereupon the object of the present invention was to provide oxide ceramics with ductile properties and slurry to be used therefore. Simultaneously, the slurry shall be of easy handling and have a low crystallization temperature.

The object is attained in generic slurry having the characterizing properties of claim 1 and in the ceramic composite having the properties of claim 10. The other dependent claims show advantageous further embodiments.

According to the invention slurry is provided comprising at least one inorganic filler and a molar-dispersed brine. Here, the brine comprises at least one carboxylate of a metal, selected from a group of oxide ceramic single or multi-component system, e.g., aluminum, magnesium, calcium, titanium, zirconium, niobium, manganese, or cerium. Preferably, here single and dual-component systems of the above-mentioned oxide ceramics are used. Also preferred are aluminum-oxide containing single or multi-component systems and particularly preferred aluminum-oxide containing single and dual-component systems.

A particular property of the present invention is that a portion of the carboxylate is formed from higher fatty acids. This defines fatty acids with at least 12 C-atoms.

The slurry according to the invention comprises molar-disperse solutions of the above-mentioned carboxylate, in which densely-crystalline fillers in the form of powder are suspended.

Now, the concept according to the invention is based on that instead of the propionic acid used in prior art here additionally longer-chained fatty acids are used to carboxylate the metal-alkoxides used, e.g., aluminum-sec.-butylate, and therefore a mixture of various metal-carboxylates is given. They are then processed together with the ceramic filler powders to form slurry. A nano-scaled open porosity is achieved by way of tempering up to 1250° C., with the pores preferably showing a diameter ranging from 3 nm to 300 nm. This nano-porous framework was also found in matrices comprising different aluminum carboxylates then forming corundum, as well as in mixtures of aluminum carboxylates with tetra-alkoxy silanes forming mullite.

According to the invention it is also possible to use other metals besides aluminum for the production of the above-mentioned nano-porous matrix. For example, yttrium and zirconium alcoholates can be converted with carboxylic acids, such as nonanoic acid and caproic acid, also resulting in a molar-disperse solution forming a nano-porous ceramic matrix when combined with fillers.

An advantage in reference to the present invention is based on the original compounds used being commercially available, non-toxic, and can be mixed without any problems, and the reactions can process in a single unit, without requiring a special structural expense.

The molar-disperse solution is mixed with powder and homogenous slurry develops, which is stable in storage over several weeks. The slurry is advantageous in that its stickiness at room temperature allows a very flexible molding, laminating, infiltrating, compressing, and adhering of the prepregs. At a temperature range from 70° C. to 120° C. the slurry, dehydrated between 20 to 50° C., develops a thermoplastic phase, which can be compacted by compression.

The carboxylate used here crystallizes preferably at temperatures below 1200° C. and then forms a nano-porous matrix with the fillers.

The low crystallization temperature of the metallic carboxylates of <1200° C. and the formation of resilient material bridges between ceramic reinforcing fibers and inorganic fillers at temperatures <1250° C. have two major advantages. The reinforcing fibers in the ceramic fiber composites are not damaged during the conversion of the prepreg into the ceramic fiber composites and the slurry forms a nano-porous structure by pyrolysis and sintering processes, allowing to distribute mechanical energies, introduced locally by way of tension or pressure, over the entire material. This nano-porous matrix therefore fulfills the requirements to create damage-tolerant oxide-ceramic fiber composites, such as formulated by F. Lang. By the use of nano-porous matrices interface-layers can be omitted, which additionally only provide insufficiently improved breakage behavior of the component and require an additional processing step by application on ceramic reinforcement fibers.

The slurry according to the invention is used to produce oxide-ceramic materials by infiltration and saturation of ceramic materials in the form of woven fibers and long fibers and a subsequent lamination to form so-called prepregs according to methods known from plastics technology. Another use relates to the production of oxide-ceramic composites by infiltration or saturation of ceramic fibrous webs, e.g., insulation material in the field of kiln engineering. It is also possible to transfer infiltrated and laminated prepregs into ceramic end products. The ceramic materials can here also be produced by coating such materials with the slurry according to the invention.

### EXAMPLE

In a 2 l-round flask 1.365 mol (336.20 g) aluminum-tri-sec.-butylate is provided, which is mixed with 1.365 mol (104.15 g) 2-isopropoxy-ethanol (exothermal reaction, formation of a tetrameric aluminum alcoholate from the trimeric aluminum-sec.-butylate). From this interim product, a mixture comprising 0.15 mol (38.46 g) palmitic acid and 0.75 mol (118.68 g) nonanoic acid is added (exothermal reaction, formation of aluminum nonate, and aluminum palmitate). Then, 1.5 mol (215.32 g) octanoic acid is added to the charge (exothermal reaction, formation of aluminum octanate) and finally 4.43 mol (327.80 g) propionic acid is added (exothermal reaction, formation of aluminum propionate). Then, for a mullite ceramics 0.495 mol (103.12 g) tetra-ethoxy-silane is added to the charge. The substance mixture is hydrolyzed with a mixture of 1.40 mol (25.19 g) deionized water and 0.135 mol (50.64 g) aluminum nitrate nonahydrate. After the hydrolysis, 75 percent by weight corundum powder with an average grain size of 1 μm is added to this solution. This suspension is then homogenized in a ball mill and the slurry according to the invention develops.

1-10. (canceled)

11. Slurry comprising at least one inorganic filler and one molar-disperse brine, comprising at least one carboxylate of aluminum, yttrium, and/or zirconium, characterized in that at least a portion of the carboxylate is based on a higher fatty acid having at least 12 C-atoms.

12. Slurry according to claim 11, characterized in that the fatty acid is selected from a group comprising palmitic acid, stearic acid, lauric acid, myristic acid, linoleic acid, oleic acid, and erucic acid.

13. Slurry according claim 11, characterized in that additionally carboxylates of the propionic acid, caproic acid, octanoic acid, nonanoic acid, acetic acid, butyric acid, valeric acid, and heptanoic acid is included.

14. Slurry according to claim 11, characterized in that the slurry has a viscosity at a range from 0.1 through 0.5 pas, measured at a shearing rate of 100 l/s at a rotation viscometer.

15. Slurry according to claim 11, characterized in that the dehydrated slurry has thermoplastic properties at a temperature range from 70 to 120° C.

16. Slurry according to claim 11, characterized in that the slurry is stable in storage for at least one month.

17. Slurry according to claim 11, characterized in that 30 to 80% by weight, particularly 50 to 75% by weight fillers are included.

18. Slurry according to claim 11, characterized in that the filler comprises a ceramic material.

19. Slurry according to claim 11, characterized in that the filler is selected from a group comprising ceramic metal oxides, particularly Al₂O₃, SiO₂, or ZrO₂.

20. A ceramic composite with ductile properties produced from slurry according to claim 11 and a ceramic material by way of tempering at temperatures ranging from 1000 to 1250° C. under the formation of a matrix having a nano-scale open porosity.

21. A ceramic composite according to claim 20, characterized in that the average diameter of the pores range from 3 to 300 nm.

22. A ceramic compound material according to claim 20, characterized in that the material is yielded in the form of fibers, particularly woven fibers or long fibers.
